(19) United States
(12) Patent Application Publication
(10) Pub. No.: US 2003/0044155 A1
(43) Pub. Date: Mar. 6, 2003

(54) Optical fiber carrier

(76) Inventor: Janice R. Maiden, Flourtown, PA (US)

Correspondence Address: John A. Chionchio, Esquire, Synnestvedt & Lechner LLP, Suite 2600, 1101 Market Street, Philadelphia, PA, 19107-2950, US

(21) Appl. No.: 10/231,681

(22) Filed: Aug. 30, 2002

Related U.S. Application Data
(60) Provisional application No. 60/316,371, filed on Aug. 31, 2001.

(51) Int. Cl. G02B 6/00; G02B 6/44

(52) U.S. Cl. 385/137; 385/100

(57) ABSTRACT

A flexible carrier for supporting and protecting elongated items such as optical fibers is disclosed. The carrier is formed from a substrate of interlaced filamentary members which may be woven, knitted or braided together. The elongated items are interlaced with or otherwise captured by the substrate during its manufacture. Various configurations of the substrate such as flat, pleated and tubular are feasible. Capture of the elongated members may be effected by integrally woven tubes formed within the substrate, by interweaving the items as warp yarns in a woven substrate or by laying in of the items in a knitted substrate.

### RELATED APPLICATION

This application is based on and claims the benefit of U.S. Provisional Application No. 60/316,371, filed Aug. 31, 2002.

### FIELD OF THE INVENTION

This invention relates to an article for supporting, organizing and protecting elongated items, particularly optical fibers.

### BACKGROUND OF THE INVENTION

It is advantageous to provide relatively delicate, elongated items such as optical fibers with an external structure which supports, protects and organizes them. Support of the fibers prevents or mitigates mechanical stresses on the fibers which can cause degradation of fiber performance or even outright fiber failure. Stresses in the fibers which adversely affect transmission of optical signals may be caused by tensile or compressive forces, as well as by merely bending the fibers. Protection is necessary because the fibers are also generally subject to physical damage due to impact, shock and abrasion which can result from rough handling during installation, as well as conditions of service. Organization of the optical fibers permits ends to be readily identified and properly and quickly terminated regardless of the length or number of fibers being considered. Such organization is an invaluable time saver when the fibers are connected to other fibers or a device because it allows the ends to be connected to the appropriate mating fiber or terminal without the need for testing and identifying each fiber before the connection is completed.

Currently, it is the practice to ensheath bundles of optical fibers within a tubular cable comprising a thin-walled outer jacket formed of flexible plastic such as PVC, PTFE, polyethylene or polypropylene. Alternatively, optical fibers are also protected in a flat ribbon of flexible plastic with the fibers arranged in spaced relation adjacent to one another across the width of the ribbon.

The jackets, tubes and ribbons used with current optical fiber cables and ribbons tend to be relatively stiff as compared with the optical fibers and, thus, may impart significant forces on the optical fibers when the cable or ribbon is handled, twisted and bent during installation and servicing. Furthermore, optical fibers within a tubular cable are substantially disorganized and must be coded for identification to enable the ends to be properly terminated. Although the fibers remain organized and easily identifiable when flat ribbon is used to protect them, there are practical considerations limiting the width of the ribbon and thereby the number of optical fibers which can be supported with a particular ribbon. There is clearly a need for improvements in the support, protection and organization of optical fibers.

### SUMMARY AND OBJECTS OF THE INVENTION

The invention concerns a flexible carrier for supporting, protecting and organizing elongated items such as optical fibers. The carrier comprises a substrate formed of a plurality of interlaced filamentary members. The elongated items are captured within the substrate during interlacing of the filamentary members and are thereby fixed in position relatively to one another within the substrate.

In a preferred embodiment, the elongated items are received within the substrate at a plurality of positions by being interlaced with the filamentary members. A group of the filamentary members is oriented transversely to and engageable with the elongated items at a plurality of crossing points positioned on opposite sides of the elongated items to fix the positions of the elongated items within the substrate. The filamentary members are preferably interlaced by weaving a first portion of them in a warp direction and a second portion of them in a fill direction. The elongated items are oriented substantially parallel to the first portion of filamentary members in the warp direction. The group engageable with the elongated items comprises a plurality of the filamentary members woven in the fill direction. These filamentary members are positioned in spaced relation to one another lengthwise along the substrate.

In an alternate embodiment, the filamentary members are interlaced by weaving and are woven about the elongated items to form a plurality of elongated tubes positioned side-by-side and connected lengthwise, the tubes capturing the elongated items.

It is an object of the invention to provide a device for supporting, organizing and protecting delicate elongated items.

It is an object of the invention to provide a device which will support elongated items without subjecting the items to harmful stress.

It is another object of the invention to provide a device in which the elongated items can be integrated during manufacture of the device.

These as well as other objects and advantages of the invention will become apparent upon further consideration of the following drawings and detailed description of preferred embodiments.

### BRIEF DESCRIPTION OF THE DRAWINGS

FIG. 1 is a perspective view of a flexible, elongated carrier adapted to receive elongated filaments such as optical fibers;

FIG. 2 is a perspective view of an alternate embodiment of the carrier shown in FIG. 1;

FIG. 3 is a perspective view of a second alternate embodiment of the carrier shown in FIG. 1;

FIG. 4 is a perspective view of another embodiment of a carrier according to the invention;

FIG. 5 is a perspective view of a second alternate embodiment of the carrier shown in FIG. 1; and

FIG. 6 is a plan view of a portion of a knitted substrate according to the invention.

### DETAILED DESCRIPTION OF THE PREFERRED EMBODIMENTS

FIG. 1 shows a carrier 10 according to the invention. Carrier 10 comprises a flexible, elongated substrate 12 comprising a plurality of filamentary members 14 interlaced together. Elongated items, for example, optical fibers 16, are positionable lengthwise along the substrate 12 and are engaged and held thereto by filamentary members 18 which are oriented within the substrate substantially transversely to the optical fibers 16 and engage them at a plurality of crossing points 17 positioned on opposite sides of the elongated items. Preferably, the filamentary members 14 comprising the substrate 12 are interlaced by weaving and the transverse filamentary members 18 comprise fill yarns in the weave. Other filamentary members 14 are oriented lengthwise along the substrate to form warp yarns 20. The optical fibers 16 are arranged substantially parallel to the warp yarns 20. Although weaving is preferred, the filamentary members 14 may also be interlaced by braiding, as well as knitting.

In the embodiment of the invention shown in FIG. 1, the optical fibers 16 are interwoven as warp yarns during manufacture of the substrate 12. The warp and fill yarns 20 and 18 provide support and protection to the interwoven optical fibers 16, the fill yarns 18 engaging the optical fibers by passing transversely over and under them and thereby retaining them to the substrate 12. The optical fibers 16 do not need to be interwoven with every fill yarn 18. Portions 19 of the optical fibers may be permitted to float along the surface of the substrate, and the fill yarns 18 which do engage the optical fibers 16 may be positioned in spaced relation along the length of the substrate 12. The warp yarns 20, being substantially parallel to the optical fibers 16, keep them consistently positioned in spaced relation across the width of the substrate. The spacing is important because it preserves the relative position of the optical fibers to one another in the substrate, allowing them to be readily identified by their position without the need for separate coding. This methodical organization of the optical fibers allows them to be quickly and correctly connected to other optical fibers via mechanical connectors or to optical devices such as optical amplifiers and modulators, without the need for testing to identify each optical fiber.

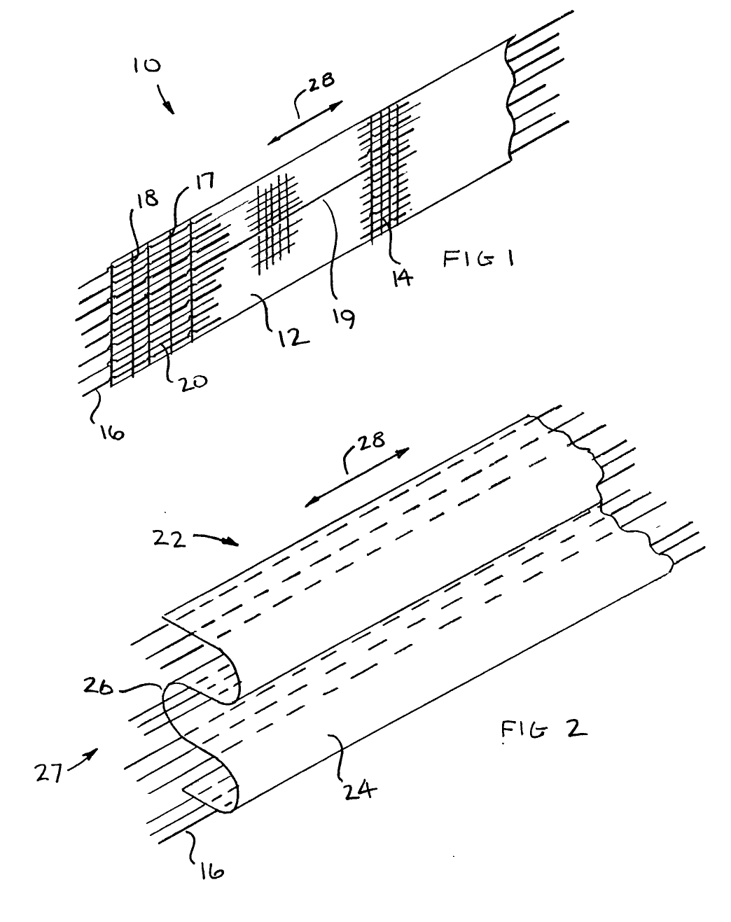

FIG. 2 illustrates an embodiment 22 of the carrier having a relatively wide substrate 24 which can be accordion folded with a plurality of reverse bends 26 forming pleats 27 extending lengthwise along the substrate substantially parallel to the warp direction indicated by arrow 28. The inherent flexibility of the woven substrate 24 allows the pleats 27 to be formed easily without placing any significant stress on the interwoven optical fibers 16, providing a relatively high density packing of optical fibers on a compact substrate. Since the substrate 24 is woven or knitted, the width may be varied over as wide a range as desired virtually without a practical limit.

FIG. 3 shows another embodiment 30 of the carrier according to the invention, again comprising a substrate 32 preferably woven of fill yarns 18 and warp yarns 20. Substrate 30 is woven into a plurality of tubes 34, each tube having an interior space 36 adapted to receive one or more optical fibers 16. The tubes are positioned side by side and connected lengthwise along a plurality of seams 38 defining and separating each of the tubes 34. Seams 38 are preferably formed by well known interweaving techniques but could also be sewn, welded or bonded. Preferably, tubes 34 are woven around the optical fibers 16 as the substrate is manufactured thereby capturing the fibers securely within the tubes.

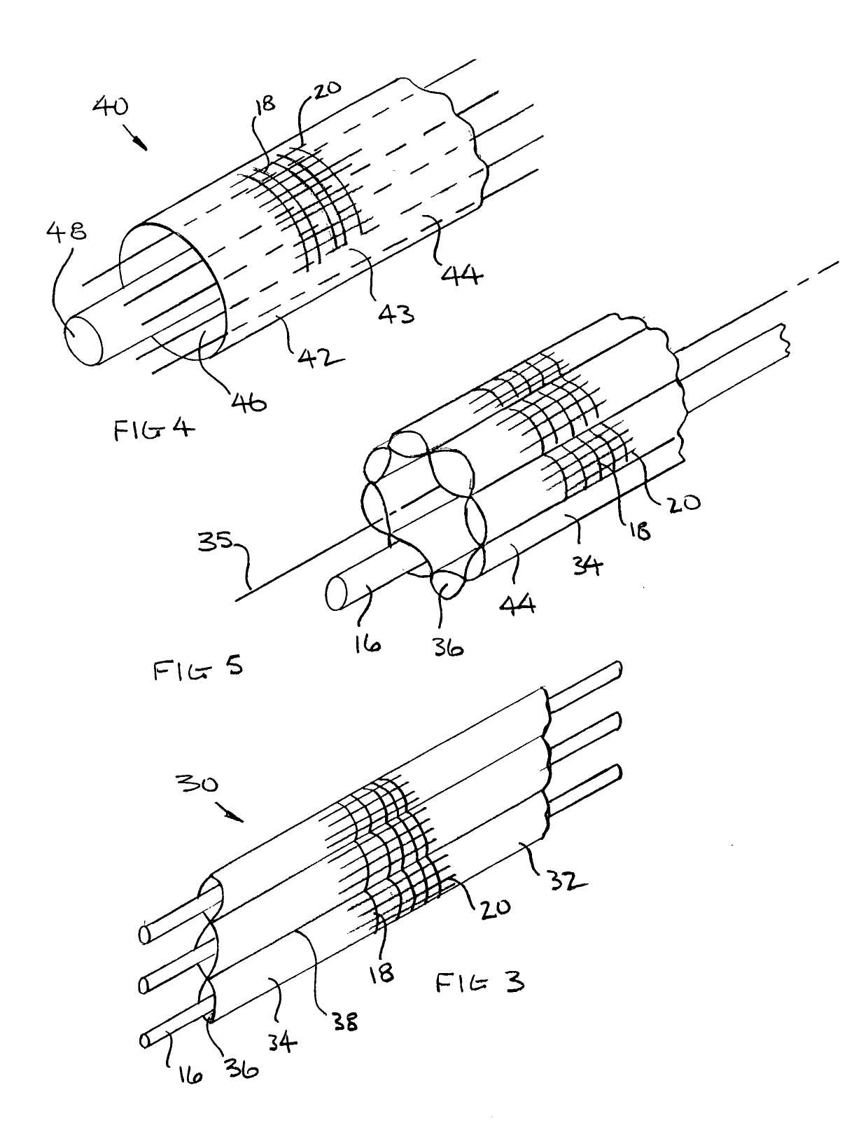

The carrier according to the invention need not be substantially flat. As shown in FIG. 4, the carrier 40 comprises a substrate 42 which forms the sidewall 43 of an elongated sleeve 44. Substrate 42 is preferably woven as a sleeve but could also be knitted or braided, or a flat substrate 12, as shown in FIG. 1, could be formed into a circular shape around its long axis parallel to the warp direction 28 and opposite edges brought together and joined, for example, by sewing, bonding or welding. The carrier embodiment 40 has optical fibers 16 interwoven as warp yarns in the sidewall 43 of the sleeve 44 and also provides an interior space 46 which may be used to house other elongated items such as a wiring harness 48.

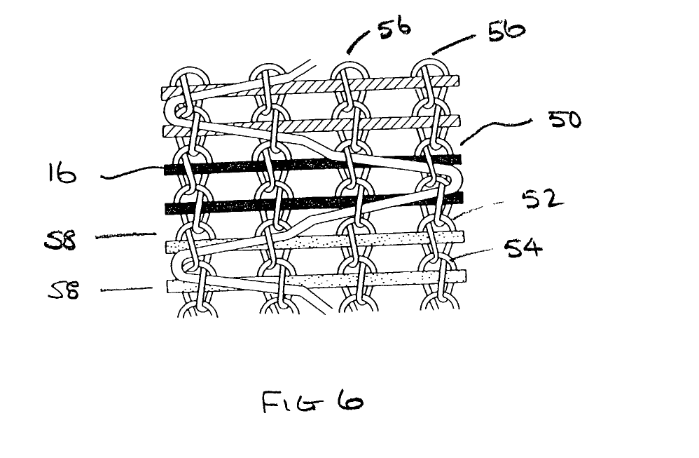

As shown in FIG. 5, sleeve 44 may also comprise tubes 34 arranged around a common center axis 35 oriented lengthwise along the sleeve, the tubes 34 each having an interior space 36 for receiving one or more optical fibers 16 or other elongated items. Similar to the flat substrate 32 shown in FIG. 3, the tubes are preferably integrally formed with the sleeve 44 and interlaced around the optical fibers 16 which during manufacture.

FIG. 6 shows how elongated items such as optical fibers 16 may be integrally positioned within a knitted substrate 50. Knitted substrate may be formed into a flat, pleated or sleeved configuration as described above for woven substrates. In the knitted substrate 50, the filamentary members 52 are interlaced in a plurality of loops 54 forming a plurality of wales 56 arranged adjacent to one another in a plurality of courses 58. The optical fibers 16 are laid into the substrate during knitting, transversely to the wales 56 and are engaged on opposite sides by the loops 54 which fix the optical fibers 16 in position within the substrate.

The properties of the warp and fill yarns 20 and 18 play a role in determining the characteristics of the various substrate embodiments. Multifilament and monofilament polyester yarns are preferred for most applications since these yarns are readily available, easily woven, knitted or braided and have excellent tensile strength, flexibility and abrasion resistance. For a more flexible substrate, multifilament yarns are preferred. Monofilament yarns provide relatively better abrasion resistance than multifilament yarns but result in a less flexible substrate. Combinations of multifilament and monofilament yarns are feasible to realize both improved abrasion resistance and flexibility.

Yarns of other materials, such as nylon and aramid fibers, may also comprise the substrate when special properties, such as high-temperature resistance or increased tensile strength are required.

In addition to varying material properties of the yarns, the properties of the weave, knit or braid can also be adjusted to achieve desirable properties for the substrate. For example, the density of the weave may be set to a relatively high number of picks per inch to provide a substrate having a relatively closed mesh which securely fixes the position of the optical fibers. The mesh may also be relatively open allowing the optical fibers to float within the weave of the substrate.

Furthermore, the pattern of the weave is another variable which may be used to achieve desired characteristics advantageous to the support and protection of the optical fibers. For example, the optical fibers may be engaged by fewer than all of the fill yarns in the weave, thereby reducing the number of contact points between the yarns and the fibers and providing relatively long runs of optical fibers which are not integrally woven in the substrate. Such a construction allows for the convenient branching of optical fibers at any desired point along the substrate.

The carrier may be manufactured by interlacing a plurality of filamentary members to form a substrate and interlacing a plurality of the optical fibers or other elongated items with the filamentary members at a plurality of positions. During interlacing, the optical fibers are oriented transversely to a group of the filamentary members which engage the optical fibers at a plurality of crossing points positioned on opposite sides of the optical fibers thereby fixing the relative position of the optical fibers within said substrate. In a woven substrate, the fill yarns comprise the transverse filamentary members which form the crossing points with the optical fibers.

Carriers comprising a plurality of filamentary members interlaced to form a substrate for the support and protection of elongated items such as optical fibers provide a durable, flexible, versatile and inexpensive means for conveying and organizing the items which is particularly suited to optical fiber applications.

What is claimed is:

1. A flexible carrier for supporting, protecting and organizing elongated items, said carrier comprising a substrate formed of a plurality of interlaced filamentary members, said elongated items being captured within said substrate during interlacing of said filamentary members and being thereby fixed in position relatively to one another within said substrate.

2. A flexible carrier according to claim 1, wherein said elongated items are captured by interlacing said elongated items with said filamentary members.

3. A flexible carrier according to claim 2, wherein said filamentary members are interlaced by weaving a first portion of said filamentary members in a warp direction and a second portion of filamentary members in a fill direction, said elongated items being interwoven with said filamentary members and oriented in said warp direction.

4. A flexible carrier according to claim 3, wherein said substrate is reverse folded along a plurality of lines oriented in said warp direction to form a plurality of pleats in said substrate.

5. A flexible carrier according to claim 3, wherein said substrate has the form of a sleeve having a sidewall surrounding an interior space, said elongated items being positioned within said sidewall.

6. A flexible carrier according to claim 1, wherein said filamentary members are interlaced by weaving, said filamentary members being woven about said elongated items to form a plurality of elongated tubes positioned side by side and connected lengthwise, said tubes capturing said elongated items.

7. A flexible carrier according to claim 6, wherein each one of said tubes is woven around one of said elongated items.

8. A flexible carrier according to claim 6, wherein said tubes are arranged around a common center to form a sleeve.

9. A flexible carrier for supporting, protecting and organizing elongated items, said carrier comprising a substrate formed of a plurality of interlaced filamentary members, said elongated items being received within said substrate at a plurality of positions by being interlaced with said filamentary members, a group of said filamentary members being oriented transversely to and engageable with said elongated items at a plurality of crossing points positioned on opposite sides of said elongated items to fix the positions of said elongated items within said substrate.

10. A flexible carrier according to claim 9, wherein said filamentary members are interlaced by weaving a first portion of said filamentary members in a warp direction and a second portion of said filamentary members in a fill direction.

11. A flexible carrier according to claim 10, wherein said elongated items are oriented substantially parallel to said first portion of filamentary members in said warp direction, said group engageable with said elongated items comprising a plurality of said filamentary members woven in said fill direction.

12. A flexible carrier according to claim 11, wherein said filamentary members woven in said fill direction and comprising said group engageable with said elongated items are positioned in spaced relation to one another lengthwise along said substrate.

13. A flexible carrier according to claim 11, wherein said substrate is reverse folded to form a plurality of pleats, said pleats extending lengthwise along said substrate substantially parallel to said warp direction.

14. A flexible carrier according to claim 11, wherein said substrate comprises a sidewall of a sleeve defining an interior space surrounded by said sidewall.

15. A flexible carrier according to claim 9, wherein said filamentary members are formed from material selected from the group consisting of polyester, nylon and aramid fibers.

16. A flexible carrier according to claim 9, wherein said filamentary members comprise monofilaments.

17. A flexible carrier according to claim 9, wherein said filamentary members comprise multifilament yarns.

18. A flexible carrier according to claim 9, wherein said elongated items comprise optical fibers.

19. A flexible carrier according to claim 9, wherein said filamentary members are interlaced by knitting said filamentary members into a plurality of loops forming a plurality of wales arranged adjacent to one another in a plurality of courses.

20. A flexible carrier according to claim 19, wherein said elongated items are oriented transversely to said wales, said elongated items being engaged on opposite sides by said loops to fix said elongated items in position within said substrate.

21. A flexible carrier comprising a plurality of elongated items and a substrate formed of a plurality of interlaced filamentary members, said elongated items being interlaced with said filamentary members at a plurality of respective positions in said substrate, a group of said filamentary members being oriented transversely to said elongated items and engaging said elongated items at a plurality of crossing points positioned on opposite sides thereof to fix the respective positions of said elongated items within said substrate.

22. A flexible carrier according to claim 21, wherein said elongated items comprise optical fibers.

23. A flexible carrier according to claim 22, wherein said filamentary members are interlaced by weaving a first portion of said filamentary members in a warp direction and a second portion of said filamentary members in a fill direction.

24. A flexible carrier according to claim 23, wherein said optical fibers are oriented substantially parallel to said first portion of filamentary members in said warp direction, said group of filamentary members engaging said optical fibers comprising a plurality of said filamentary members woven in said fill direction.

25. A flexible carrier according to claim 24, wherein said filamentary members woven in said fill direction and comprising said group engaging said elongated items are positioned in spaced relation to one another lengthwise along said substrate.

26. A flexible carrier according to claim 24, wherein said substrate is reverse folded to form a plurality of pleats, said pleats extending lengthwise along said substrate substantially parallel to said warp direction.

27. A flexible carrier according to claim 24, wherein said substrate comprises a sidewall of a sleeve defining an interior space surrounded by said sidewall.

28. A method of making a flexible carrier for supporting, protecting and organizing optical fibers, said method comprising the steps of:
interlacing a plurality of filamentary members to form a substrate; and
interlacing a plurality of said optical fibers with said filamentary members at a plurality of positions and oriented transversely to a group of said filamentary members, said group of filamentary members engaging said optical fibers at a plurality of crossing points positioned on opposite sides of said optical fibers thereby fixing the relative position of said optical fibers within said substrate.
